(19) United States
(12) Patent Application Publication
(10) Pub. No.: US 2018/0197174 A1
(43) Pub. Date: Jul. 12, 2018

(54) Systems and Methods for Use in Facilitating Transactions to Payment Accounts

(71) Applicant: MASTERCARD INTERNATIONAL INCORPORATED, Purchase, NY (US)

(72) Inventor: Marthom Daetz, St. Louis, MO (US)

(21) Appl. No.: 15/400,023

(22) Filed: Jan. 6, 2017

(51) Int. Cl. G06Q 20/40

(52) U.S. Cl. CPC G06Q 20/401; G06Q 20/4018

(57) ABSTRACT

Systems and methods are provided for use in facilitating payment account transactions. One exemplary method includes initially issuing, by a computing device, a transaction code to a communication device associated with a consumer for use in a transaction to a payment account by the consumer. The method then includes intercepting, by the computing device, an authorization request including a pseudo primary account number (PAN) for the consumer's transaction, where the pseudo PAN includes the transaction code, and identifying, by the computing device, a PAN for the payment account associated with the transaction code included in the pseudo PAN. The method further includes replacing, by the computing device, the pseudo PAN with the identified PAN for the consumer's payment account, and routing the authorization request with the PAN to an issuer of the consumer's payment account.

### FIELD

The present disclosure generally relates to systems and methods for use in facilitating transactions to payment accounts, and in particular, to systems and methods for facilitating such transactions through use of merchant-specific codes for merchants involved in the transactions and consumer-specific codes for consumers involved in the transactions, in lieu of primary account numbers for the payment accounts.

### BACKGROUND

This section provides background information related to the present disclosure which is not necessarily prior art.

Merchants are known to offer various different products (e.g., goods and services, etc.) for sale to consumers. Consumers, in turn, are known to fund purchases of such products from the merchants through payment accounts, often via payment devices such as, for example, credit cards, etc. The credit cards, for example, include payment account credentials for the consumers' payment accounts such as primary account numbers (PANs), consumer names, expiration dates, etc., embossed on the credit cards and encoded into magnetic stripes and/or chips on the cards. As such, when used in transactions for the products, the merchants typically receive (e.g., physically receive, etc.) the credit cards from the consumers and present the credit cards to point-of-sale (POS) terminals (e.g., swipe the credit cards at the POS terminals, insert the credit cards into the POS terminals, etc.), which in turn read the payment account credentials for the payment accounts from the cards (e.g., via the magnetic stripes and/or the chips, etc.). Then, the merchants return the credit cards to the consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating transactions to payment accounts;

FIG. 2 is a block diagram of a computing device that may be used in the exemplary system of FIG. 1;

FIG. 3 is an exemplary method that may be implemented in the system of FIG. 1 for use in facilitating a transaction to a payment account associated with a consumer through use of a pseudo PAN generated for the transaction; and

FIG. 4 is an exemplary interface that may be used in the system of FIG. 1 and/or the method of FIG. 3 to facilitate a transaction to a payment account using a transaction code for the payment account and through use of a pseudo PAN generated for the transaction comprising the transaction code.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transactions may be initiated by consumers, at merchants, through payment accounts by presenting payment devices such as, for example, prepaid cards, debit cards, credit cards, etc., associated with the payment accounts, to the merchants. The merchants, in turn, may take possession of the payment devices to facilitate the transactions at point-of-sale (POS) terminals. While in possession of the payment devices, it is possible for the merchants' employees or others to view and, in some instances, fraudulently acquire payment account credentials from the payment devices (e.g., primary account numbers (PANs), expiration dates, card verification codes (CVCs), etc.). At some later time, then, the employees or others may use the payment account credentials in unauthorized transactions. Uniquely, the systems and methods herein permit the consumers to present transaction codes to the merchants in connection with such payment account transactions, in lieu of presenting the payment devices, to facilitate the transactions to the consumers' payment accounts. In particular herein, in anticipation of a transaction, a consumer requests and is provided a transaction code, by an engine, which is valid for a defined interval. Then, in the transaction, the consumer provides the transaction code to the merchant, in lieu of his/her payment device. In turn, the merchant combines the transaction code with a merchant code for the merchant, to form a pseudo PAN specific to the transaction. The merchant then generates and transmits, to a payment network (via an acquirer associated with the merchant), an authorization request for the transaction with the pseudo PAN included therein. In this manner, the consumer is able to initiate the transaction to his/her payment account without actually putting a payment device in the possession of the merchant, thereby reducing the potential for a person (e.g., an employee of the merchant, or otherwise, etc.) improperly recording and/or capturing payment account credentials for the consumer's payment account, and thereby enhancing security associated with the transaction at the merchant.

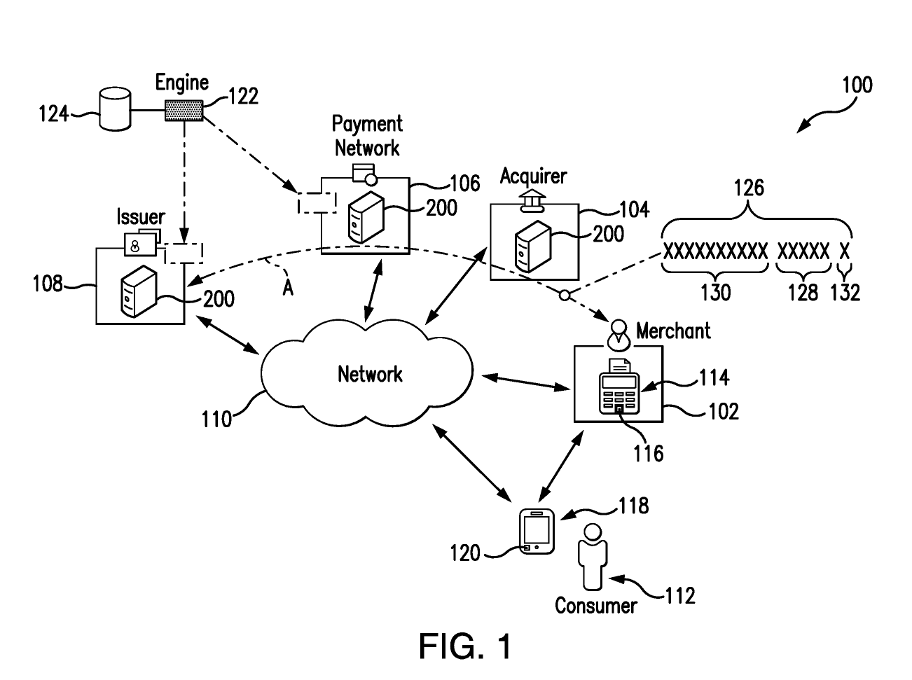

FIG. 1 illustrates an exemplary system 100, in which the one or more aspects of the present disclosure may be implemented. Although the system 100 is presented in one arrangement, other embodiments may include systems arranged otherwise depending, for example, on a manner in which payment account transactions are processed, a manner in which transaction codes are generated and transmitted to consumers, etc.

In the illustrated embodiment, the system 100 generally includes a merchant 102, an acquirer 104 associated with the merchant 102 (for processing transactions performed at the merchant 102), a payment network 106, and an issuer 108 configured to issue payment accounts to consumers, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which is accessible as desired to the merchant 102, the payment network 106, the issuer 108, and one or more various consumers in the system 100 (e.g., consumer 112, etc.), etc.

The merchant 102 in the system 100 is generally associated with products (e.g., goods and/or services, etc.) for purchase by one or more consumers (including the consumer 112). The merchant 102 offers the products for sale at a merchant location (e.g., a brick-and-mortar location, etc.). As shown in FIG. 1, the merchant includes a point-of-sale (POS) terminal 114, which includes a POS application 116. The POS application 116 includes executable instructions, which cause the POS terminal 114 to compile and transmit authorization requests for payment account transactions performed at the merchant 102 and/or to further operate as otherwise described herein (e.g., to compile pseudo primary account numbers (pseudo PANs), etc.). With that said, when the POS terminal 114 is described as configured to perform various operations herein, it should be appreciated that it may be doing so generally in coordination with the application 116 (even if the application 116 is not specifically referenced), or not.

In addition in the system 100, the consumer 112 is associated with a payment account, which is issued to the consumer 112 by issuer 108 and suitable to provide funds for transactions with the merchant 102 (or at other merchants as desired). The consumer 112 is further associated with a communication device 118, which in the illustrated embodiment generally includes a portable communication device such as a smartphone, a tablet, a laptop, etc. As shown, in FIG. 1, the communication device 118 includes a transaction application 120, and the transaction application 120 includes executable instructions that cause the communication device 118 to perform the various operations described herein. In at least one embodiment, the transaction application 120 includes and/or is incorporated into a payment application (e.g., a virtual wallet application, etc.), such as, for example, PayPass® from MasterCard®, Apple Pay® from Apple®, PayWave® from Visa®, etc., or other suitable application offered by the merchant 102, by the payment network 106, by the issuer 108, or by other entities (be it a payment application or otherwise). In connection therewith, upon installing the transaction application 120 to the communication device 118, the consumer 112 is generally prompted to register his/her payment account to the transaction application 120 (and provide various credentials for the payment account, such as the PAN, the CVC, the expiration date, etc.), for subsequent use as described herein. With that said, when the communication device 118 is described as configured to perform various operations herein, it should be appreciated that it may be doing so generally in coordination with the application 120 (even if the application 120 is not specifically referenced), or not.

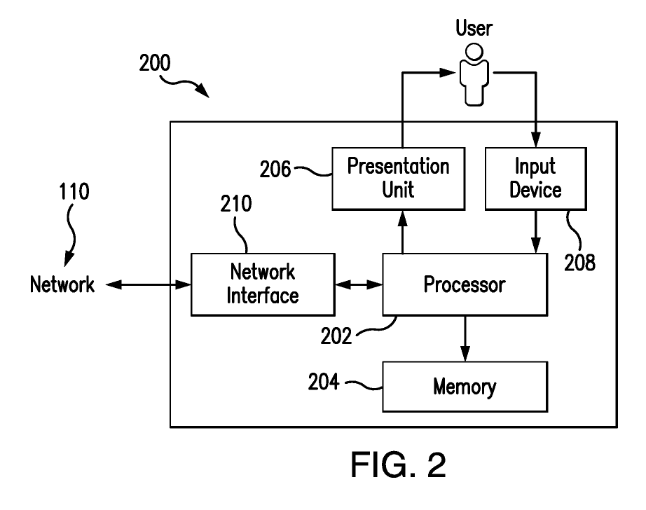

FIG. 2 illustrates an exemplary computing device 200 that can be used in the system 100. The computing device 200 may include, for example, one or more servers, workstations, personal computers, POS terminals, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the acquirer 104, the payment network 106, and the issuer 108 are illustrated as including, or being implemented in, computing device 200, coupled to the network 110. In addition, the POS terminal 114 at the merchant 102 and the communication device 118 associated with the consumer 112 are also consistent with computing device 200. Further, in various implementations of the system 100, the merchant 102 may include at least one additional computing device consistent with computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, payment account credentials for payment accounts (e.g., PANs, expiration dates, CVCs, etc.), consumer-specific codes (e.g., transaction codes, etc.), merchant-specific codes, pseudo PANs, and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., transaction codes, pseudo PANs, etc.), either visually or audibly to a user of the computing device 200, for example, to the consumer 112 in the system 100, to users associated with other parts of the system 100, etc. And, various interfaces (e.g., as defined by network-based applications, webpages, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, requests for transaction codes, requests to perform purchase transactions, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device (e.g., the communication device 118, etc.), behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 210) incorporated into or with the processor 202.

Referring again to FIG. 1, the system 100 includes a code engine 122, which is configured, by executable instruction, to perform the operations described herein. In the illustrated embodiment, the code engine 122 is provided as a separate part of the system 100 and in communication with the payment network 106, for example (and/or the issuer 108). As such, the code engine 122 may be considered a computing device consistent with computing device 200. However, as shown in FIG. 1, the code engine 122 may be incorporated, partly or entirely, into the payment network 106 and/or the issuer 108 (and their representative computing devices 200), as indicated by the dotted lines extending from the code engine 122. But again, regardless of location, the code engine 122 is coupled to and/or is in communication with the payment network 106 and/or the issuer 108 to perform one or more of the operation described herein.

Further, the system includes a data structure 124 coupled to (and in communication with) the code engine 122. In particular, for example, the data structure 124 may be included in the memory 204 associated with the code engine 122 (although this is not required in all embodiments). In connection therewith, the code engine 122 may be configured to enroll the consumer's transaction application 120 with the code engine 122, and store the consumer's payment account (and the credentials associated therewith) in the data structure 124 (so that the consumer 112 can make use of transaction codes in transactions, as described herein). As indicated above, this may be done by the code engine 122 upon installation of the transaction application 120 to the communication device 118 (automatically, or upon authorization from the consumer 112). Or, this may be done as part of an additional service associated with the consumer's payment account. In addition, the code engine 122 may be configured to enroll the merchant 102 and the merchant's POS application 116 with the code engine 122, and store a merchant ID (for the merchant 102) and/or a terminal ID (associated with the POS terminal 114), for example, in the data structure 124 for use in subsequently identifying authorization requests from the enrolled merchant 102 as potentially including transaction codes as described herein (so that the merchant 102 can receive/accept transaction codes from consumers in connection with purchase transactions, in lieu of PANs). This merchant enrollment may be done by the code engine 122 upon installation of the POS application 116 to the POS terminal 114 (automatically, or upon authorization from the merchant 102 and/or the acquirer 104), or otherwise. In so doing, the code engine 122 then assigns a merchant-specific code (e.g., a partial PAN, etc.) to the merchant 102 for use herein (in all transaction code-based transactions), along with a CVC and an expiration date for/specific to the merchant-specific code.

In this exemplary embodiment, when the consumer 112 desires to initiate a payment account transaction with the merchant 102, for example, the consumer 112 provides a corresponding input to the communication device 118 (e.g., via input device 208, etc.), which is received at the transaction application 120. In turn, the communication device 118 is configured, by the transaction application 120, to transmit a request for a transaction code for the transaction to the code engine 122 (in combination with providing details for the consumer's payment account by which the transaction is to be ultimately funded). In response, the code engine 122 is configured to receive the request, to generate the transaction code for the transaction (e.g., a 3-7 character code, a code having a different length than 3-7 characters, etc.) and store the transaction code in the data structure 124 in association with the consumer's payment account, to initiate a timer associated with an expiration interval of the transaction code (e.g., to store a time and/or a date the transaction code is issued in the data structure 124 in association with the transaction code and the consumer's payment account, etc.), and to transmit the transaction code to the communication device 118, and specifically, to the transaction application 120. The transaction application 120 then causes the transaction code to be displayed, at the communication device 118 (e.g., at the presentation unit 206, etc.), to the consumer 112. It should be appreciated that the transaction code may be generated/assigned in any desired manner. For example, the code engine 122 may have a listing of predetermined transaction codes (stored in the data structure 124) from which it then selects one for assignment to the consumer 112 (and then removes the selected transaction code from the listing so it is not reused). The selected transaction code is then associated with the consumer and/or the consumer's payment account in the data structure 124 (e.g., along with the expiration interval for the transaction code, etc.). As another example, the code engine 122 may randomly generate the transaction code for the consumer 112 and then include the transaction code in a listing of active transaction codes in the data structure 124 (and further associate the generated transaction code with the consumer 112 and/or the consumer's payment account in the data structure 124). Then, each time the code engine 122 generates a new transaction code, it may initially compare the new transaction code to the listing of active transaction codes prior to assigning the transaction code to the consumer to ensure that it is not already in use.

Then, in connection with performing the payment account transaction with the merchant 102, the consumer 112 presents the transaction code to the merchant 102, and specifically, to an employee of the merchant 102. The employee provides the transaction code to the POS terminal 114, and specifically, to the POS application 116. In response, and a shown in FIG. 1, the POS terminal 114 is configured, by the POS application 116, to compile a pseudo PAN 126 for the transaction. Broadly, the pseudo PAN includes at least the transaction code received from the consumer 112. With that said, in the illustrated system 100, the pseudo PAN 126 generally includes the transaction code (at 128) received from the consumer 112 and the merchant-specific code (at 130) for the merchant 102 (e.g., a 5-10 character code representative of the merchant 102, a code having a length other than 5-10 characters, etc.). In particular in this embodiment, the transaction code 128 includes a 5 digit code, and the merchant-specific code includes a 10 digit code. In at least one embodiment, the POS terminal 114 is configured to further compile the pseudo PAN to conform to one or more payment network restriction(s) (e.g., to add a check digit consistent with the Luhn algorithm such as digit 132 in the pseudo PAN 126 of FIG. 1, etc.). As such, in this example, the pseudo PAN 126 may be generally consistent in length to a traditional PAN. In any case, once the pseudo PAN is compiled, the POS terminal 114 is configured to then compile an authorization request for the transaction, including the pseudo PAN therein, and also potentially including an expiration date and a CVC for the pseudo PAN (and more particularly, for the merchant-specific code assigned to the merchant 102, etc.), and to transmit the authorization request to the acquirer 104 (associated with the merchant 102), along path A in the system 100. Upon receipt, the acquirer 104 communicates the authorization request to the issuer 108, along path A, generally through the payment network 106, such as, for example, through MasterCard®, VISA®, Discover®, American Express®, etc.

Uniquely herein, the code engine 122 is configured to identify the authorization request as including the pseudo PAN, for example, based on at least a portion of the pseudo PAN (e.g., based on a bank identification number (BIN) included in the pseudo PAN as part of the transaction code, for example, being within a defined range; based on the merchant-specific code included in the pseudo PAN being within a specific range; etc.). When identified, the code engine 122 is configured to intercept the authorization request, at a point along path A (depending on where the code engine 122 is incorporated in the system 100), and to match the transaction code included in the pseudo PAN (from the authorization request) to a PAN for the consumer's payment account stored in the data structure 124. And, when such a match is found, the code engine 122 is configured to include the PAN for the consumer's payment account in the authorization request in place of the pseudo PAN. The code engine 122 may also be configured to include an appropriate expiration date and CVC for the consumer's payment account, as also retrieved from the data structure 124, in the authorization request. The code engine 122 is configured to then permit the authorization request to continue to the issuer 108. In addition, the code engine 122 may be configured to also notify the acquirer 104 of the PAN being associated with the authorization request, of the transaction, and/or of the pseudo PAN (e.g., for use by the acquirer 104 in subsequently clearing and/or settling the transaction, etc.).

Often, upon identification of the authorization request, the code engine 122 is configured to further determine if the transaction code is expired or not (e.g., prior to including the PAN in the authorization request, at a different time, etc.). When the transaction code is not expired, the code engine 122 is configured to then permit the authorization request to continue to the issuer 108. Alternatively, when the transaction code is expired, the code engine 122 may be configured to decline the authorization request.

Finally, upon receipt of the authorization request at the issuer 108 (e.g., when the transaction code is not expired, etc.), the issuer 108 determines if the consumer's payment account is in good standing and if there is sufficient funds and/or credit to cover the transaction. If approved, an authorization reply (indicating the approval of the transaction) is transmitted by the issuer 108 back to the merchant 102, again along path A (without being intercepted by the code engine 122), thereby permitting the merchant 102 to continue the transaction. The transaction is later cleared and/or settled by and between the merchant 102, the acquirer 104, and the issuer 108. If the transaction is declined by the issuer 108, however, an authorization reply (indicating a decline of the transaction) is provided by the issuer 108 back to the merchant 102, thereby permitting the merchant 102 to halt or terminate the transaction or request an alternative form of payment.

Transaction data is generated, collected, and stored as part of the above exemplary interactions among the merchant 102, the acquirer 104, the payment network 106, the issuer 108, and the consumer 112. The transaction data includes a plurality of transaction records, one for each transaction, or attempted transaction, by the consumer 112 (or by other consumers). The transaction records, in this exemplary embodiment, are stored at least by the payment network 106 (e.g., in a data structure associated with the payment network 106, etc.), but could be stored in other parts of the system 100 and transmitted as needed or requested. As used herein, transaction data may include, for example (and without limitation), pseudo PANs (and the various parts thereof), PANs, amounts of the transactions, merchant IDs for merchants involved in the transactions, merchant category codes (MCCs), balances, payment history, dates/times of the transactions/payments, incentives used (e.g., rebates discounts, etc.), etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, associated engines, etc., to use data collected during enrollment and/or collected in connection with processing the transactions herein, subsequently for one or more of the different purposes described herein.

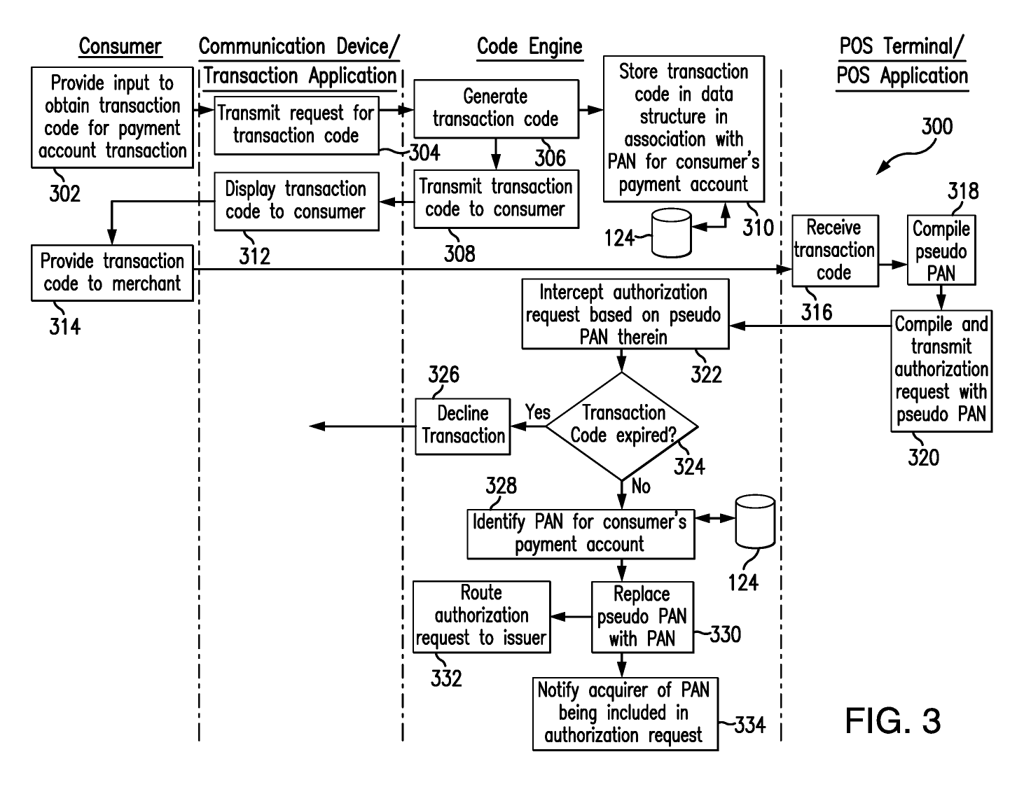

FIG. 3 illustrates an exemplary method 300 for use in facilitating a payment account transaction to a payment account based on a transaction code for the payment account and through use of a pseudo PAN for the transaction, comprising the transaction code. The exemplary method 300 is described with reference to the system 100 and the computing device 200. However, it should be understood that the method 300 is not limited to the system 100 or the computing device 200. And, likewise, the systems and the computing devices herein should not be understood to be limited to the exemplary method 300.

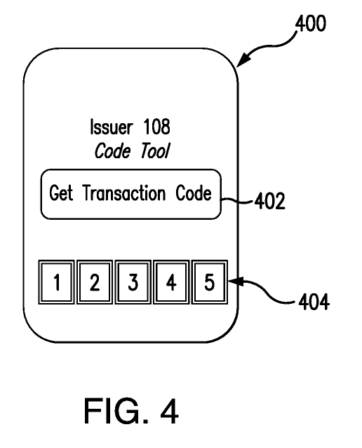

The method 300 is further described with reference to a transaction scenario between the consumer 112 and the merchant 102, where the merchant 102 includes a restaurant. In particular, the consumer 112 is attempting to pay a food bill at the merchant 102 through use of the consumer's payment account. Moreover, the method 300 is described with reference to an exemplary interface 400, as shown in FIG. 4. It should be appreciated, however, that the particular restaurant scenario and the exemplary interface 400 are used for purposes of illustration only and should not be understood to limit the scope of method 300 and, more generally, the scope of any of the methods herein and/or any of the systems herein.

With reference now to FIG. 3, in the example restaurant scenario, to perform a payment account transaction with the merchant 102 to pay the consumer's bill, the consumer 112 initially provides an input to the transaction application 120, via the communication device 118, at 302, to obtain a transaction code for the transaction. In particular, for example, with reference to the interface 400 of FIG. 4, the communication device 118 displays the interface 400 to the consumer 112 (e.g., via presentation unit 206, upon selection of the transaction application 120 at the communication device 118, etc.), and the consumer 112 selects a “Get Transaction Code” button 402 at the communication device 118 (e.g., via input device 208, etc.). In turn, the transaction application 120 receives the input (e.g., the selection of the button 402, etc.) and transmits a request for the transaction code to the code engine 122, at 304, via the network 110 (and via the communication device 118). In connection therewith, the transaction application 120 generally includes various credentials for the consumer's payment account (which is to be used to ultimately fund the transaction), so that the code engine 122 can ultimately match the assigned transaction code to the consumer's payment account.

In response to the code request, the code engine 122 generates, at 306, a transaction code for the transaction to the payment account. As described above in the system 100, the transaction code may be generated in a variety of manners, including, without limitation, by random number generation, selection from a listing of transaction codes, etc.

Once the transaction code is generated, the code engine 122 transmits the transaction code to the consumer's communication device 118, as the device that requested the transaction code, at 308. In addition, the code engine 122 stores the transaction code in the data structure 124, at 310, in association with the PAN for the consumer's payment account to which the transaction is to be directed. More specifically (and as described above in the system 100), the communication device 118 and/or the transaction application 120 are registered to the code engine 122 for the services herein (e.g., upon installation of the transaction application 120 to the communication device 118, upon enrollment of the consumer's payment account for the services described herein, at another time, etc.), such that when the request for the transaction code is received at the code engine 122, the request includes content indicative of the communication device 118 and/or the transaction application 120 (e.g., a media access control (MAC) address for the communication device 118, an application ID for the transaction application 120, etc.). Such content is then used, by the code engine 122, to identify the payment account to which the transaction is to be directed (e.g., in the data structure 124, etc.), and further the PAN for the payment account. Alternatively (and as generally described above), the code request may directly include the credentials for the payment account to which the transaction is to be directed. Regardless, when stored in the data structure 124 (at 310), the transaction code is stored in association with the PAN for the consumer's payment account. Further, the transaction code is stored in the data structure 124 with the date and time at which the transaction code was issued. In this manner, as describe below, the code engine 122 is able to determine whether the transaction code is expired, or not, when an authorization request for the underlying transaction, containing the transaction code, is subsequently received by the code engine 122.

As an example, when the code engine 122 receives the code request from the consumer 112, it may determine that the code request is associated with a PAN for consumer's payment account of 5123456789012346, having an expiration of MM/YYYY. This may be done based on direct inclusion of the PAN in the code request. Or, this may be done based on inclusion of content indicative of the communication device 118 and/or the transaction application 120, which is then translated to the PAN for the consumer's payment account. In either case, in response, the code engine 122 generates and assigns a transaction code of 12345 to the transaction and pairs the code to the PAN 5123456789012346. And, the code engine 122 transmits the transaction code to the consumer 112, and also stores it in association with the PAN in the data structure 124. Then, the code engine 122 waits for a transaction from a merchant comprising the transaction code 12345 (e.g., the code engine 122 waits to receive an authorization request for a transaction from an enrolled merchant comprising the transaction code 12345, etc.).

Next in the method 300, when the transaction code is received at the communication device 118, the transaction application 120 displays the transaction code to the consumer, at the communication device 118, at 312 (e.g., via the presentation unit 206, etc.). In particular, for example, in the interface 400 shown in FIG. 4, the transaction code is filled into the bottom section 404 of the interface 400 (for display to the consumer 112, at 312 in the method 300). Once displayed, the consumer 112 is able to relay the transaction code to the merchant 102, at 314, and in particular in the restaurant scenario, to his/her server of the merchant 102, for example, by telling the server the transaction code, or by writing the transaction code on the check, or further, by showing the server the communication device 118 and thereby permitting the server to record the transaction code. Next, the merchant server provides the transaction code to the POS terminal 114 (e.g., manually, via communication with the consumer's communication device 118 (e.g., via the network interface 210 of the consumer's communication device 118, etc.), etc.).

In turn, the POS application 116 (via the POS terminal 114) receives the transaction code, at 316, from the consumer 112 and compiles a pseudo PAN for the transaction, at 318, comprising the transaction code. In particular, in this example, the POS terminal 114 includes memory, such as, for example, memory 204, which includes the merchant-specific code for the merchant 102, an expiration date for the code, and a CVC for the code. And, the POS application 116 compiles the pseudo PAN for the transaction based on the transaction code received from the consumer 112 and the merchant-specific code retrieved from the memory, with (in this example, and without limitation) the merchant-specific code making up the first 10 digits of the pseudo PAN and the transaction code then making up the next 5 digits. Further, the POS application 116 adds a check digit to the pseudo PAN, consistent with the Luhn algorithm, to ensure that the acquirer 104 and/or the payment network 106 accepts the pseudo PAN when transmitted by the merchant 102 (as part of an authorization request for the transaction). Generally, in this manner, the POS application 116 compiles the pseudo PAN to have a consistent format with a typical PAN (e.g., comprising 16 digits, etc.). With that said, it should be appreciated that the pseudo PAN may be compiled in other manners by the code engine 122 in other embodiments, to potentially yield the pseudo PAN in one or more different formats (e.g., comprising different numbers of digits, comprising different combinations of data/codes/digits, etc.).

With continued reference to FIG. 3, after the pseudo PAN is compiled, the POS application 116 compiles an authorization request for the transaction, at 320. The authorization request includes the pseudo PAN, along with various details of the transaction such as an amount of the transaction, a time/date of the transaction, a merchant category code (MCC) for the merchant 102, a terminal ID for the POS terminal 114 used in the transaction, etc. Further, the POS application 116 also includes in the authorization request the expiration date and the CVC for the merchant-specific code, from the memory of the POS terminal 114, for association with the compiled/generated pseudo PAN. The POS terminal 114 and/or the POS application 116 then transmits the authorization request to the acquirer 104 (associated with the merchant 102 for facilitating the authorization request), which in turn directs the authorization request to the issuer 108 (associated with the consumer's payment account being used in the transaction) for review via the payment network 106 (along path A in FIG. 1, as described above).

During the transmission of the authorization request from the merchant 102 to the issuer 108, along path A in FIG. 1, however, the code engine 122 uniquely intercepts the authorization request, at 322, generally based on the pseudo PAN included therein (or at least identifies the authorization request as including the pseudo PAN, if the authorization request is not yet actually intercepted). For example, the code engine 122 may identify the authorization request as including the pseudo PAN (and not a regular PAN), based on the pseudo PAN in the authorization request being within a range of pseudo PANs, being stored in the data structure 124 in a listing of active pseudo PANs (e.g., comprising active merchant-specific codes and active transaction codes, etc.), based on a portion of the pseudo PAN (e.g., the transaction code, the merchant-specific code, etc.) being with a range of values, etc. As an example, the code engine 122 may include a list of all merchant-specific codes that have been issued to enrolled merchants (as stored in the data structure 124 during enrollment of the merchants), and then only accept/intercept authorization requests that include merchant-specific codes in the list.

Then, upon identification/interception of the authorization request (based on inclusion of the pseudo PAN, based on the merchant-specific code included in the pseudo PAN, etc.), the code engine 122 determines, at 324, whether the transaction code in the pseudo PAN is expired or not. In so doing, the code engine 122 may retrieve, from the data structure 124, the date and time at which the transaction code was issued and compare it to the date and time of the transaction (as included in the authorization request for the transaction), or potentially to a current date and time when the code engine 122 is performing the comparison. When the code engine 122 determines that the transaction code is expired (e.g., when a duration between the two dates/times exceeds a predefined threshold (e.g., exceeds fifteen minutes, thirty minutes, sixty minutes, two hours, durations therebetween, other durations, etc.), when the transaction code is determined to have already been used, etc.), the code engine 122 declines the transaction (and the corresponding authorization request), at 326. In connection therewith, the code engine 122 may also transmit a communication to the consumer 112, at the consumer's communication device 118 (e.g., via the transaction application 120, via an email, via a SMS message, etc.) indicating that the transaction code provided by the consumer 112 to the merchant 102 (at 314) is expired and that a new transaction code should be requested for the transaction (as desired).

Conversely, when the code engine 122 determines (at 324) that the transaction code is not expired, the code engine 122 actually intercepts the authorization request (if not already done) and searches in the data structure 124 to match the transaction code included in the pseudo PAN (from the authorization request) to the PAN for the consumer's payment account, at 328. And, when such a match is found, the code engine 122 replaces the pseudo PAN in the authorization request with the identified PAN, at 330 (e.g., the code engine 122 overwrites the pseudo PAN with the identified PAN, etc.). The code engine 122 may also be configured to include the appropriate expiration date and CVC for the consumer's payment account, as also retrieved from the data structure 124, in the authorization request. In other embodiments, however, the code engine 122 may instead simply append the PAN to the authorization request (without deleting or otherwise altering the pseudo PAN already included therein). Regardless, the code engine 122 then permits the authorization request, with the PAN for the consumer's payment account included therein, to continue to the issuer 108, at 332. In addition, the code engine 122 also notifies the acquirer 104 of the PAN being associated with the authorization request, of the transaction, and/or of the pseudo PAN (e.g., for use by the acquirer 104 in subsequently clearing and/or settling the transaction, etc.), at 334.

Finally, as described above in the system 100, upon receipt of the authorization request at the issuer 108, the issuer 108 determines if the consumer's payment account is in good standing and if there are sufficient funds and/or credit to cover the transaction. If the transaction is approved, an authorization reply (indicating the approval of the transaction) is transmitted by the issuer 108 back to the merchant 102, again along path A in FIG. 1 (without being intercepted by the code engine 122), thereby permitting the merchant 102 to continue the transaction. The transaction is later cleared and/or settled by and between the merchant 102, the acquirer 104, and the issuer 108. If the transaction is declined by the issuer 108, however, an authorization reply (indicating a decline of the transaction) is provided by the issuer 108 back to the merchant 102, thereby permitting the merchant 102 to halt or terminate the transaction or request an alternative form of payment.

In view of the above, the systems and methods herein may permit enhanced security for consumers in connection with payment account transactions at merchants, where the consumers traditionally present payment devices to the merchants when purchasing products, by allowing the consumers to present transaction codes to the consumers (as associated with the consumers' payment accounts) in connection with the purchases instead of their actual payment devices. In so doing, the consumers are able to initiate the purchase transactions to their payment accounts without actually putting their corresponding payment devices in the possession of the merchants (and without actually providing payment account credentials for their payment accounts to the merchants). As such, the potential for individuals associated with the merchants, and/or other individuals in general, to fraudulently record and/or capture the payment account credentials for the consumer's payment account is reduced if not eliminated.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) issuing a transaction code to a communication device associated with a consumer for a transaction to a payment account; (b) intercepting an authorization request including a pseudo primary account number (PAN), the pseudo PAN including the transaction code; (c) identifying a PAN for the payment account associated with the transaction code included in the pseudo PAN; (d) replacing the pseudo PAN with the identified PAN; (e) routing the authorization request with the PAN to an issuer of the payment account; and (f) determining if the transaction code is expired and declining the transaction when the transaction code is expired.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating a payment account transaction, the method comprising:
issuing, by a computing device, a transaction code to a communication device associated with a consumer for a transaction to a payment account;
intercepting, by the computing device, an authorization request including a pseudo primary account number (PAN), the pseudo PAN including the transaction code;
identifying, by the computing device, a PAN for the payment account associated with the transaction code included in the pseudo PAN;
replacing, by the computing device, the pseudo PAN with the identified PAN; and
routing the authorization request with the PAN to an issuer of the payment account.

2. The computer-implemented method of claim 1, wherein the transaction code includes at least four digits; and
wherein the pseudo PAN further includes a code specific to a merchant involved in the transaction.

3. The computer-implemented method of claim 2, wherein the code specific to the merchant includes at least 8 digits, such that the pseudo PAN and the PAN define a consistent format.

4. The computer-implemented method of claim 1, wherein issuing the transaction code includes generating the transaction code, in response to a request from the communication device associated with the consumer, and transmitting the transaction code to the communication device.

5. The computer-implemented method of claim 1, further comprising determining if the transaction code is expired and declining the transaction when the transaction code is expired; and
wherein replacing the pseudo PAN with the identified PAN includes replacing the pseudo PAN with the identified PAN when the transaction code is not expired.

6. The computer-implemented method of claim 5, wherein intercepting the authorization request includes intercepting the authorization request based on a part of the pseudo PAN being within a defined range; and
wherein the part of the pseudo PAN includes at least a bank identification number (BIN) of the pseudo PAN, the BIN including at least six digits.

7. The computer-implemented method of claim 5, wherein intercepting the authorization request includes intercepting the authorization request based on a pseudo PAN indicator.

8. A system for use in facilitating a transaction to a payment account, the system comprising:
a memory including a primary account number (PAN) for a payment account; and
at least one processor coupled to the memory and configured to:
issue a transaction code for a transaction to the payment account;
store the transaction code in the memory in association with the PAN;
intercept an authorization request for the transaction to the payment account, based on a pseudo PAN included in the authorization request, the pseudo PAN including the transaction code;
identify the PAN for the payment account, in the memory, based on the transaction code associated with the PAN; and
replace the pseudo PAN with the PAN in the authorization request and cause the authorization request, with the PAN included therein, to be routed to an issuer of the payment account, thereby permitting the issuer to authorize the transaction in response to the authorization request, while obscuring the PAN from a merchant involved in the transaction using the pseudo PAN.

9. The system of claim 8, wherein the at least one processor is further configured to:
determine whether the transaction code is expired or not expired;
cause the transaction to be declined when the transaction code is expired; and
replace the pseudo PAN with the PAN in the authorization request when the transaction code is not expired.

10. The system of claim 9, wherein the at least one processor is further configured to:
record a time and/or date of issuance of the transaction code; and
determine whether the transaction code is expired based on a defined interval and the recorded time and/or date.

11. The system of claim 8, further comprising a non-transitory computer readable storage media for use in a communication device associated with a consumer, including executable instructions, which when executed by a processor in the communication device, cause said processor to request the transaction code for the transaction in response to an input from the consumer.

12. The system of claim 8, further comprising a non-transitory computer readable storage media for use in a point of sale (POS) terminal, including executable instructions, which when executed by a processor in the POS terminal, cause said processor to:
compile the pseudo PAN from at least the transaction code and a merchant-specific code for a merchant involved in the transaction; and
compile and transmit the authorization request for the transaction including the pseudo PAN, and also including an expiration date and a card verification code (CVC) for the merchant-specific code, as stored in a memory associated with the processor.

13. The system of claim 12, wherein the at least one processor coupled to the memory is further configured to replace the expiration date included in the authorization request with an expiration date associated with the PAN and included in the memory.

14. A non-transitory computer readable storage media including executable instructions for facilitating payment account transactions based on transaction codes, which when executed by at least one processor, cause the at least one processor to:
intercept an authorization request for a transaction to a payment account, the authorization request including a pseudo primary account number (PAN), the pseudo PAN including a transaction code;
match the pseudo PAN to a PAN, in a memory, based on the transaction code, the PAN associated with a payment account;
replace, in the authorization request, the pseudo PAN with the PAN; and
cause the authorization request, with the PAN included therein, to be routed to an issuer of the payment account, thereby permitting the issuer to authorize the transaction in response to the authorization request, while obscuring the PAN from a merchant involved in the transaction through use of the pseudo PAN.

15. The non-transitory computer readable storage media of claim 14, wherein the executable instructions, when executed by the at least one processor, further cause the at least one processor to:
issue the transaction code, in response to a request for the transaction from a communication device associated with the payment account, and
transmit the transaction code to the communication device.

16. The non-transitory computer readable storage media of claim 14, wherein the transaction code includes at least three characters.

17. The non-transitory computer readable storage media of claim 14, wherein the executable instructions, when executed by the at least one processor, further cause the at least one processor to:
determine whether the transaction code included in the intercepted authorization request is expired or not expired;
cause the transaction to be declined when the transaction code is expired; and
replace the pseudo PAN with the PAN only when the transaction code is not expired.

18. The non-transitory computer readable storage media of claim 14, wherein the pseudo PAN further includes a code specific to the merchant involved in the transaction.

19. The non-transitory computer readable storage media of claim 18, wherein the executable instructions, when executed by the at least one processor, further cause the at least one processor to notify an acquirer associated with the merchant of the PAN matched to the pseudo PAN, thereby permitting the acquirer to clear and settle the transaction after the transaction is approved by the issuer.

20. The non-transitory computer readable storage media of claim 14, wherein the PAN and the pseudo PAN define a consistent format.
